(19) United States
(12) Patent Application Publication
(10) Pub. No.: US 2025/0203268 A1
(43) Pub. Date: Jun. 19, 2025

(54) Earphone Adjustment Structure and Ear-Hook Type Earphones

(71) Applicant: SHENZHEN GRANDSUN ELECTRONIC CO., LTD., Shenzhen (CN)

(72) Inventors: Jiugao Peng, Shenzhen (CN); Haiquan Wu, Shenzhen (CN); Chuan Wang, Shenzhen (CN); Ruiwen Shi, Shenzhen (CN); Zhijun Zhang, Shenzhen (CN); Yu Wang, Shenzhen (CN)

(21) Appl. No.: 18/978,061

(22) Filed: Dec. 12, 2024

(30) Foreign Application Priority Data
Dec. 13, 2023 (CN) 202311719196.5

(51) Int. Cl. H04R 1/10

(52) U.S. Cl. CPC H04R 1/105; H04R 1/1008

(57) ABSTRACT

An earphone adjustment structure includes a rotation shaft, a sliding sleeve and a fixed sleeve. The rotation shaft has a shaft axis, one end of the rotation shaft along the shaft axis is configured to be connected to an ear hook of an ear-hook type earphone. The sliding sleeve is sleeved on the rotation shaft and capable of rotating relative to the rotation shaft around the shaft axis. The fixed sleeve is sleeved on the sliding sleeve and capable of sliding relative to the rotation shaft and the sliding sleeve along the shaft axis, and can be maintained at a preset position along the shaft axis. The sliding sleeve is driven to rotate synchronously when the fixed sleeve rotates relative to the rotation shaft around the shaft axis. The fixed sleeve is configured to be connected to an earphone body of the ear-hook type earphone.

### CROSS-REFERENCE TO RELATED APPLICATION

This application claims priority to Chinese Patent Application No. 202311719196.5 filed Dec. 13, 2023, the disclosure of which is hereby incorporated by reference in its entirety.

### BACKGROUND

### Technical Field

The present disclosure relates to the field of earphone technology, more particularly to an earphone adjustment structure and ear-hook type earphones.

### Technical Considerations

The statements provided herein are merely background information related to the present disclosure, and do not necessarily constitute prior art. With the progress and development of society, earphones have been widely used in people's work and life, and in order to meet people's needs for earphones, various earphones have emerged, such as headphones, ear-hook type earphones, neckband earphones, etc. Among them, the ear-hook type earphones refer to earphones with auxiliary hanging decoration added to the side of the earphones for easy wearing and use. The ear-hook type earphones have good wearing stability and thus are suitable for various sports scenes.

However, the shape and size of each person's ears are different. Generally, the ear sizes of male users and female users are quite different, and the existing ear-hook type earphones are mainly fixed in size and the size is relatively single. As a result, when some users wear ear-hook type earphones, the sound outlet of the earphone body cannot be well aligned with the user's ear canal, which thus will affect the user's experience.

### SUMMARY

Accordingly, provided are improved earphone adjustment structures and ear-hook type earphones that address the technical problem that the ear-hook type earphones in the existing technology are mainly fixed in size and the size is relatively single, which leads to the fact that for some users when the ear-hook type earphones are worn on, the sound outlet of the earphone bodies cannot be well aligned with the ear canals of the users.

To achieve the above objective, and in non-limiting embodiments or aspects, the present disclosure provides an earphone adjustment structure, which includes: a rotation shaft, a sliding sleeve and a fixed sleeve.

The rotation shaft has a shaft axis, one end of the rotation shaft along the shaft axis is configured to be connected to an ear hook of an ear-hook type earphone.

The sliding sleeve is sleeved on the rotation shaft and capable of rotating relative to the rotation shaft around the shaft axis.

The fixed sleeve is sleeved on the sliding sleeve, capable of sliding relative to the rotation shaft and the sliding sleeve along the shaft axis, and capable of being maintained at a preset position along the shaft axis. The fixed sleeve is enabled to rotate synchronously with the sliding sleeve around the shaft axis relative to the rotation shaft. The fixed sleeve is configured to be connected to an earphone body of the ear-hook type earphone.

In some non-limiting embodiments or aspects, a displacement of the fixed sleeve relative to the sliding sleeve and the rotation shaft along the shaft axis is in a range of 0-2 mm.

In some non-limiting embodiments or aspects, the earphone adjustment structure also includes a resistance ring. The resistance ring is sleeved on an outer wall of the sliding sleeve and abuts against an inner wall of the fixed sleeve.

In some non-limiting embodiments or aspects, the fixed sleeve is provided with an annular recess arranged around the shaft axis, and the resistance ring is accommodated in the annular recess.

In some non-limiting embodiments or aspects, a guide slot is provided on a side wall of the sliding sleeve, a guide block is provided on an inner wall of the fixed sleeve, and the guide block is slidably arranged in the guide slot along the shaft axis. Or alternatively, the guide block is provided on the outer wall of the sliding sleeve, and a guide slot is provided on the side wall of the fixed sleeve, and the guide block is slidably arranged in the guide slot along the shaft axis.

In some non-limiting embodiments or aspects, a limit groove extending around the shaft axis is provided on an inner wall of the sliding sleeve, and two opposite ends of the limit groove are spaced apart and disconnected in a circumferential direction of the shaft axis, and a boss inserted into the limit groove is provided on a side wall of the rotation shaft. Or alternatively, the limit groove extending around the shaft axis is provided on the side wall of the rotation shaft, and the two opposite ends of the limit groove are spaced apart and disconnected in the circumferential direction of the shaft axis, and the boss inserted into the limit groove is provided on the inner wall of the sliding sleeve.

In some non-limiting embodiments or aspects, the earphone adjustment structure also includes a shift plate. The shift plate is connected to the rotation shaft, a first step surface is formed on the rotation shaft, and the first step surface and the shift plate are arranged oppositely and spaced apart along the shaft axis, and two ends of the sliding sleeve along the shaft axis abut against the first step surface and the shift plate respectively.

In some non-limiting embodiments or aspects, the earphone adjustment structure also includes a torsion spring. The torsion spring is arranged within the sliding sleeve and sleeved on the rotation shaft, and the torsion spring is configured to provide a restoring force to the sliding sleeve.

In some non-limiting embodiments or aspects, the earphone adjustment structure also includes a shift plate. The shift plate is connected to the rotation shaft, a second step surface is formed on the rotation shaft, and the second step surface and the shift plate are arranged oppositely and spaced apart along the shaft axis. The torsion spring is arranged between the second step surface and the shift plate along the shaft axis.

In accordance with non-limiting embodiments or aspects of the present disclosure, an ear-hook type earphone is also provided, which includes an earphone body, an ear hook and the earphone adjustment structure according to any of the above options, one end of the rotation shaft is connected to the ear hook, and the fixed sleeve is connected to the earphone body.

Compared with the existing technology, the earphone adjustment structure and ear-hook type earphones provided by the present disclosure can achieve at least the followings beneficial effects: by connecting one end of the rotation shaft to the ear hook and connecting the fixed sleeve to the earphone body, the fixed sleeve can drive the earphone body to move closer to or away from the ear hook along the shaft axis when the fixed sleeve slides along the shaft axis relative to the sliding sleeve and the rotation shaft, so that an overall size of the ear-hook type earphone can be adjusted. Since the sliding sleeve can be maintained at a preset position along the shaft axis, the earphone body can be positioned. When the fixed sleeve and the sliding sleeve rotate around the shaft axis relative to the rotation shaft, the earphone body is driven by the fixed sleeve to rotate relative to the ear hook to adjust the deflection angle of the earphone body relative to the ear hook on the shaft axis. The earphone adjustment structure of the present disclosure has sliding and rotating adjustment functions, which allows the size of the ear-hook type earphone to be adjustable. Thus, when wearing and using, the user can adjust the position of the earphone body according to the user's own needs, so that the sound outlet on the earphone body can be better aligned with the user's ear canal, and the earphone body fits the user's ear better, which is conducive to improving the user's experience, adapting to more users, and increasing the applicable population of the ear-hook type earphones.

### BRIEF DESCRIPTION OF THE DRAWINGS

In order to illustrate the technical solutions in the embodiments of the present disclosure more clearly, the drawings that need to be used in description of the embodiments will be briefly introduced below. Obviously, the drawings described below are only some embodiments of the present disclosure. For persons skilled in the art, other drawings may also be obtained based on these drawings without exerting creative efforts.

FIG. 1 is a schematic diagram of a three-dimensional structure of one earphone provided in non-limiting embodiments or aspects of the present disclosure;

FIG. 2 is a right-view structural diagram of an earphone adjustment structure provided in non-limiting embodiments or aspects of the present disclosure;

FIG. 3 is a schematic diagram of a cross-sectional structure along A-A shown in FIG. 2;

FIG. 4 is a schematic diagram of a cross-sectional structure along B-B shown in FIG. 2;

FIG. 5 is an exploded decomposition structural diagram of the earphone adjustment structure provided in non-limiting embodiments or aspects of the present disclosure; and

FIG. 6 is a schematic diagram of a partial three-dimensional structure of a sliding sleeve provided in non-limiting embodiments or aspects of the present disclosure, in which a fixed sleeve and a decorative cover are omitted.

### DETAILED DESCRIPTION

To make the above objectives, features and advantages of the present disclosure more comprehensible and clearer, the detailed description of the present disclosure is illustrated in detail below in conjunction with the drawings. In the following description, many specific details are set forth to facilitate a full understanding of the present disclosure. However, the present disclosure may be implemented in many other ways different from those described herein, and persons skilled in the art may make similar improvements without violating the connotation of the present disclosure, so the present disclosure is not limited by the specific embodiments or aspects disclosed below.

In the description of the present disclosure, it should be understood that the orientation or position relationship indicated by the terms “center”, “longitudinal”, “lateral”, “length”, “width”, “thickness”, “up”, “down”, “front”, “rear”, “left”, “right”, “vertical”, “horizontal”, “top”, “bottom”, “inside”, “outside”, “clockwise”, “counterclockwise”, “axial”, “radial”, “circumferential” and the like is based on the orientation or position relationship shown in the drawings, which is only for the convenience of describing the present disclosure and simplifying the description, and does not indicate or imply that the device or element referred to must have a specific orientation, be constructed and operated in a specific orientation, and therefore cannot be construed as a limitation on the present disclosure.

In addition, the terms “first” and “second” are only used for descriptive purposes and cannot be understood as indicating or implying relative importance or implicitly indicating the number of technical features indicated. Thus, a feature defined as “first” and “second” may explicitly or implicitly include at least one of the features. In the description of the present disclosure, the term “multiple” means at least two, such as two, three, etc., unless otherwise clearly defined.

In the present disclosure, unless otherwise clearly defined or limited, the terms “installed”, “in connection”, “connected”, “fixed” and the like should be understood in a broad sense, for example, it may be a fixed connection, a detachable connection, or an integral body, it may be a mechanical connection or an electrical connection, it may be directly connected or indirectly connected through an intermediate medium, and it may be an internal connection of two elements or an interaction relationship between two elements, unless otherwise clearly defined. For persons skilled in the art, the specific meanings of the above terms in the present disclosure can be understood according to the specific circumstances.

In the present disclosure, unless otherwise clearly defined or limited, a first feature “above” or “below” a second feature may be that the first and second features are in direct contact with each other, or the first and second features are indirectly connected through an intermediate medium. Moreover, the first feature “on”, “over” and “above” the second feature may be the first feature directly above or obliquely above the second feature, or simply means that the first feature is higher in level than the second feature. The first feature “below”, “under” and “down” the second feature may be the first feature directly below or obliquely below the second feature, or simply means that the first feature is lower in level than the second feature.

It should be noted that when an element is referred to as “fixed to” or “arranged on” another element, the element may be directly on the other element or may be fixed to (or arranged on) the other element through an intermediate component. When an element is considered to be “connected to” another element, it may be directly connected to the other element or it may also have a intermediate component. The terms “vertical”, “horizontal”, “up”, “down”, “left”, “right” and similar expressions used herein are for illustrative purposes only and are not intended to limit the implementations.

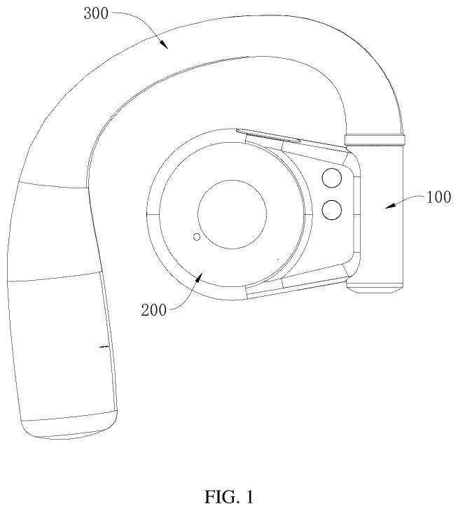

Referring to FIGS. 1 to 6, and the earphone adjustment structure 100 provided in non-limiting embodiments or aspects of the present disclosure is now described for adjusting the size of each ear-hook type earphone.

Referring to FIGS. 1 to 3, the earphone adjustment structure 100 includes: a rotation shaft 10, a sliding sleeve 20 and a fixed sleeve 30. The rotation shaft 10 has a shaft axis a. One end of the rotation shaft 10 along the shaft axis a is configured to be connected to an ear hook 300 of the ear-hook type earphone. The sliding sleeve 20 is sleeved on the rotation shaft 10 and is rotatable relative to the rotation shaft 10 around the shaft axis a. The fixed sleeve 30 is sleeved on the sliding sleeve 20 and is slidable relative to the rotation shaft 10 and the sliding sleeve 20 along the shaft axis a, and can be maintained at a preset position along the shaft axis a. The fixed sleeve 30 is enabled to rotate synchronously with the sliding sleeve 20 around the shaft axis a relative to the rotation shaft 10. The fixed sleeve 30 is configured to be connected to an earphone body 200 of the ear-hook type earphone.

It should be noted that in the non-limiting embodiments or aspects of the present disclosure, along the shaft axis a refers to an axial direction of the shaft axis a, that is, along an extension direction of the shaft axis a, and rotating around the shaft axis a is a circumferential rotation along the shaft axis a.

Herein, most of the rotation shaft 10 is accommodated within the sliding sleeve 20 and the fixed sleeve 30, and one end of the rotation shaft 10, passing through one end of the sliding sleeve 20 and the fixed sleeve 30 along the shaft axis a, is fixedly connected to one end of the ear hook 300. The sliding sleeve 20 and the fixed sleeve 30 are both coaxially arranged with the rotation shaft 10, and the sliding sleeve 20 is accommodated within the fixed sleeve 30.

The sliding sleeve 20 can rotate relative to the rotation shaft 10 around the shaft axis a, but the sliding sleeve 20 cannot slide relative to the rotation shaft 10 along the shaft axis a. The fixed sleeve 30 can slide along the shaft axis a relative to the sliding sleeve 20 and the rotation shaft 10, but the fixed sleeve 30 cannot rotate relative to the sliding sleeve 20. When the fixed sleeve 30 slides along the shaft axis a relative to the rotation shaft 10 and the sliding sleeve 20, the earphone body 200 is driven by the fixed sleeve 30 to slide synchronously along the shaft axis a, which allows the earphone body 200 to move closer to or away from the ear hook 300 along the shaft axis a, so that the overall size of the ear-hook type earphone can be adjusted to fit the ears of most users. When the fixed sleeve 30 and the sliding sleeve 20 rotate around the shaft axis a relative to the rotation shaft 10, the earphone body 200 is driven by the fixed sleeve 30 to rotate relative to the ear hook 300, which allows a deflection angle of the earphone body 200 relative to the ear hook 300 on the shaft axis a to be adjustable, so that the earphone body 200 can be better fitted to the user's ear when wearing and using.

The fixed sleeve 30 can be maintained at the preset position along the shaft axis a when the fixed sleeve 30 is capable of sliding to a preset position along the shaft axis a, to position the earphone body 200 on the shaft axis a and prevent the earphone body 200 from shaking up and down relative to the ear hook 300.

Compared with the prior art, the earphone adjustment structure 100 provided in the present disclosure is configured by connecting one end of the rotation shaft 10 to the ear hook 300 and connecting the fixed sleeve 30 to the earphone body 200. When the fixed sleeve 30 slides along the shaft axis a relative to the sliding sleeve 20 and the rotation shaft 10, the earphone body 200 is driven by the fixed sleeve 30 to move closer to or away from the ear hook 300 along the shaft axis a, so that the overall size of the ear-hook type earphone can be adjusted. Since the sliding sleeve 20 can be maintained at a preset position along the shaft axis a, the earphone body 200 can be positioned. The earphone body 200 is driven by the fixed sleeve 30 to rotate relative to the ear hook 300 when the fixed sleeve 30 and the sliding sleeve 20 rotate around the shaft axis a relative to the rotation shaft 10, so that the deflection angle of the earphone body 200 relative to the ear hook 300 on the shaft axis a can be adjusted. The earphone adjustment structure 100 of the present disclosure has sliding and rotation adjustment functions, which allows the size of the ear-hook type earphone to be adjustable. Thus, when wearing and using, the user can adjust the position of the earphone body 200 according to the user's own needs, so that the sound outlet holes on the earphone body 200 can be better aligned with the user's ear canal, and the earphone body 200 can fit the user's ear better, which is conducive to improving the user's usage experience, adapting to more users, and increasing the applicable population of the ear-hook type earphones.

In some non-limiting embodiments or aspects, and referring to FIG. 1 to FIG. 3, two ends of the rotation shaft 10 along the shaft axis a are respectively a first connection end 11 and a second connection end 12. The first connection end 11, extending through one end of the sliding sleeve 20 and the fixed sleeve 30, is fixedly connected to one end of the ear hook 300. The sliding sleeve 20 is open near the first connection end 11. Both ends of the fixed sleeve 30 are open, and a side wall of the fixed sleeve 30 along the shaft axis a is connected to the earphone body 200.

In non-limiting embodiments or aspects of the present disclosure, a displacement of the fixed sleeve 30 relative to the sliding sleeve 20 and the rotation shaft 10 along the shaft axis a is in a range of 0-2 mm.

By setting the displacement of the fixed sleeve 30 relative to the sliding sleeve 20 and the rotation shaft 10 along the shaft axis a to be in the range of 0-2 mm, the use needs of most users can be met.

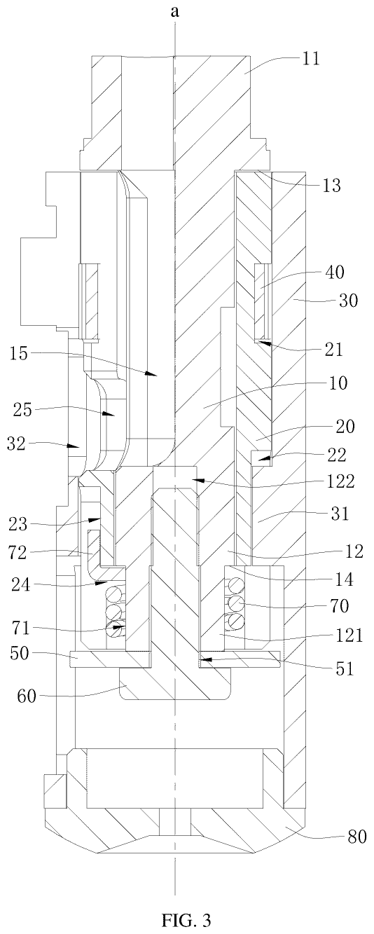

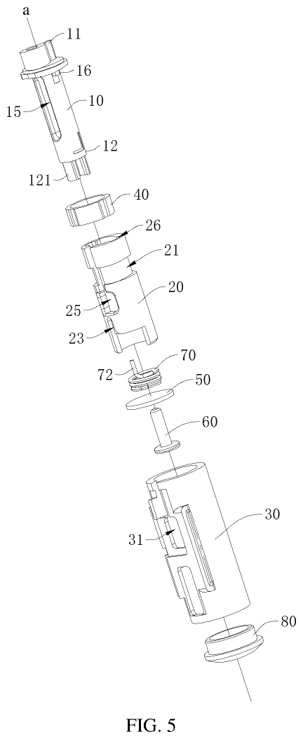

In non-limiting embodiments or aspects of the present disclosure, referring to FIG. 3 and FIG. 5. The earphone adjustment structure 100 also includes a resistance ring 40, which is sleeved on an outer wall of the sliding sleeve 20 and abuts against an inner wall of the fixed sleeve 30.

Specifically, the resistance ring 40 is fixedly sleeved on the outer wall of the sliding sleeve 20 and is arranged close to the first connection end 11, so that the resistance ring 40 cannot be displaced relative to the sliding sleeve 20 along the shaft axis a. The resistance ring 40 abuts against the inner wall of the fixed sleeve 30, so that the resistance ring 40 and the inner wall of the fixed sleeve 30 are in friction contact, and the resistance ring 40 is configured to increase a resistance of the fixed sleeve 30 to slide.

In some non-limiting embodiments or aspects, a material of the resistance ring 40 may be but not limited to silicone, rubber, etc. The resistance ring 40 is made of silicone, rubber, etc., so that the resistance ring 40 has good elasticity, thereby, it can be effectively ensured that the resistance ring 40 is stably abutted between the sliding sleeve 20 and the fixed sleeve 30, but will not generate resistance to the fixed sleeve 30 that makes the fixed sleeve 30 difficult to slide.

In the above technical solution, the resistance ring 40 is arranged to be sleeved on the outer wall of the sliding sleeve 20 and abut against the inner wall of the fixed sleeve 30, to increase the resistance of the fixed sleeve 30 to slide along the shaft axis a, so that within a preset range, the fixed sleeve 30 can be maintained at any position under the resistance of the resistance ring 40, to allow the positioning of the earphone body 200 on the shaft axis a, which effectively prevents the earphone body 200 from loosening, and because the fixed sleeve 30 can be maintained at any position under the resistance of the resistance ring 40, the users are enabled to adjust the distance between the earphone body 200 and the ear hook 300 more accurately according to the users' own needs, that is, the size of the ear-hook type earphone can be more accurately adjusted, so that the ear-hook type earphones can better meet the needs of the users.

In non-limiting embodiments or aspects of the present disclosure, an annular recess 21 arranged around the shaft axis a is provided on the fixed sleeve 30, and the resistance ring 40 is accommodated in the annular recess 21.

In some non-limiting embodiments or aspects, the annular recess 21 is arranged near the first connection end 11.

By clamping the resistance ring 40 in the annular recess 21, the resistance ring 40 can be stably sleeved on the fixed sleeve 30, effectively preventing the resistance ring 40 from being displaced relative to the sliding sleeve 20 along the shaft axis a.

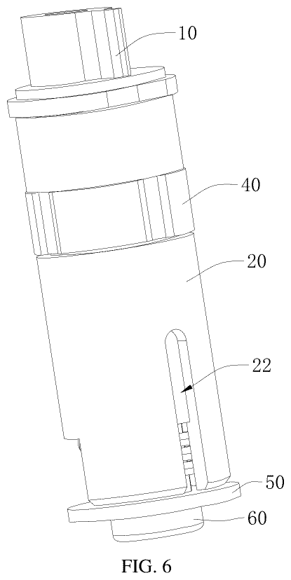

In non-limiting embodiments or aspects of the present disclosure, referring to FIGS. 3 and 6, a guide slot 22 is provided on a side wall of the sliding sleeve 20, and a guide block 31 is provided on the inner wall of the fixed sleeve 30, and the guide block 31 is slidably provided in the guide slot 22 along the shaft axis a.

Specifically, the guide block 31 is extended along the shaft axis a, protruded from the inner wall surface of the fixed sleeve 30, and arranged close to the first connection end 11. The guide slot 22 is also extended along the shaft axis a, and the guide slot 22 penetrates the side wall of the sliding sleeve 20 at an end portion close to the second connection end 12. The guide block 31 is inserted into the guide slot 22 along the radial direction of the shaft axis a. When the fixed sleeve 30 slides along the shaft axis a, the guide block 31 slides along the shaft axis a in the guide slot 22. In addition, the guide block 31 is matched with the guide slot 22 along the circumferential direction of the shaft axis a, so that the guide block 31 cannot move around the shaft axis a in the guide slot 22.

The guide block 31 is arranged slidably along the shaft axis a in the guide slot 22, so that when the fixed sleeve 30 slides along the shaft axis a, the guide block 31 slides in the guide slot 22 to guide the fixed sleeve 30, which is beneficial to improve the sliding stability of the fixed sleeve 30. In the meantime, the guide block 31 and the guide slot 22 cooperate circumferentially along the shaft axis a, so that the guide block 31 cannot move around the shaft axis a in the guide slot 22, which allows the fixed sleeve 30 and the sliding sleeve 20 to be clamped in the circumferential direction of the shaft axis a, so that the fixed sleeve 30 and the sliding sleeve 20 cannot rotate relative to each other, thus, the fixed sleeve 30 can only slide relative to the sliding sleeve 20 along the shaft axis a, and cannot rotate relative to the sliding sleeve 20 around the shaft axis a, that is, the sliding sleeve 20 is driven to rotate synchronously when the fixed sleeve 30 rotates.

In should be noted that, in non-limiting embodiments or aspects, the guide block 31 may be provided on the outer wall of the sliding sleeve 20, the guide slot 22 may be provided on the inner wall of the fixed sleeve 30, and the guide block 31 is slidably provided in the guide slot 22 along the shaft axis a.

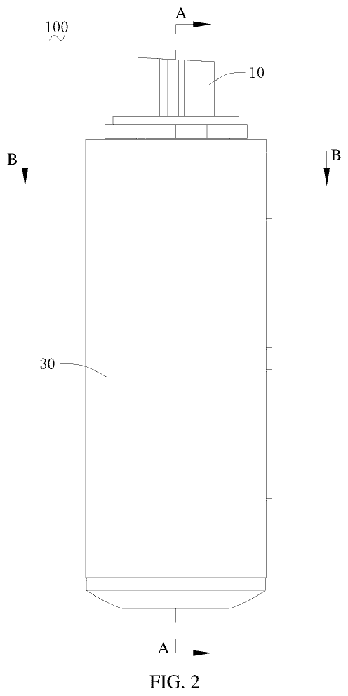

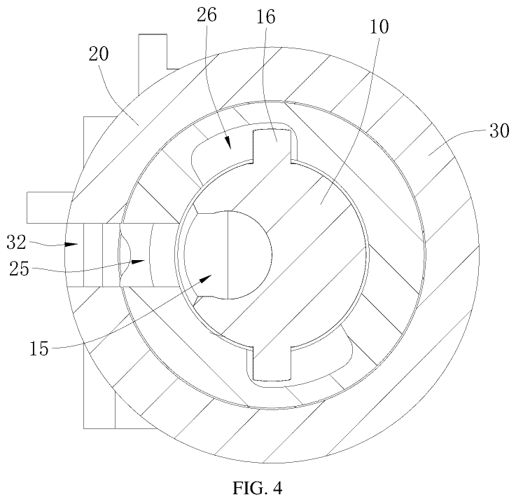

In non-limiting embodiments or aspects of the present disclosure, referring to FIG. 2 and FIG. 4, a limit groove 26 extending around the shaft axis a is provided on an inner wall of the sliding sleeve 20. In the axial direction of the shaft axis a, the limit groove 26 is provided close to the first connection end 11. In the circumferential direction of the shaft axis a, the two opposite ends of the limit groove 26 are spaced apart and disconnected. A boss 16 inserted into the limit groove 26 is provided on a side wall of the rotation shaft 10. The boss 16 is provided close to the first connection end 11. In the axial direction of the shaft axis a, the boss 16 is fitted with the limit groove 26, so that the boss 16 cannot be displaced relative to the limit groove 26 along the axial direction of the shaft axis a.

Specifically, when the sliding sleeve 20 rotates around the shaft axis a relative to the rotation shaft 10, the boss 16 moves around the shaft axis a in the limit groove 26. Since the two opposite ends of the limit groove 26 are not connected, a movement range of the boss 16 is limited by the two opposite ends of the limit groove 26, so that the rotation range of the sliding sleeve 20 is limited, thereby the deflection angle of the earphone body 200 relative to the ear hook 300 is limited.

In some non-limiting embodiments or aspects, the limit groove 26 is in an arc shape around the shaft axis a, and the maximum angle of the boss 16 moving in the limit groove 26 is in a range of 15°-20°, that is, the maximum deflection angle of the earphone body 200 relative to the ear hook 300 is in a range of 15°-20°. In some non-limiting embodiments or aspects, the maximum deflection angle of the earphone body 200 relative to the ear hook 300 is 15°, that is, the earphone body 200 can be deflected by 0°-15 relative to the ear hook 300.

In the above technical solution, the rotation range of the sliding sleeve 20 relative to the rotation shaft 10 can be limited by the cooperation of the boss 16 and the limit groove 26, thereby the deflection angle of the earphone body 200 relative to the ear hook 300 can be limited. In addition, the rotation shaft 10 and the sliding sleeve 20 can be clamped along the shaft axis a, so that the rotation shaft 10 and the sliding sleeve 20 cannot slide relative to each other along the shaft axis a, that is, the sliding sleeve 20 is driven to slide synchronously when the rotation shaft 10 slides along the shaft axis a.

It can be understood that, in non-limiting embodiments or aspects, the side wall of the rotation shaft 10 may also be provided with the limit groove 26 extending around the shaft axis a, and in the circumferential direction of the shaft axis a, the two opposite ends of the limit groove 26 are spaced apart and not connected, and the inner wall of the sliding sleeve 20 is provided with the boss 16 inserted into the limit groove 26.

In non-limiting embodiments or aspects of the present disclosure, referring to FIG. 3, the earphone adjustment structure 100 also includes a shift plate 50, which is connected to the rotation shaft 10, and a first step surface 13 is formed on the rotation shaft 10, and the first step surface 13 and the shift plate 50 are arranged oppositely and spaced apart along the shaft axis a, and the two ends of the sliding sleeve 20 respectively abut against the first step surface 13 and the shift plate 50 along the shaft axis a.

Specifically, the shift plate 50 is connected to the second connection end 12 of the rotation shaft 10, the first step surface 13 is arranged close to the first connection end 11, the sliding sleeve 20 is arranged between the first step surface 13 and the shift plate 50 along the shaft axis a, and one end of the sliding sleeve 20 abuts against the first step surface 13, and the other end of the sliding sleeve 20 abuts against the shift plate 50.

In the above technical solution, the two ends of the sliding sleeve 20 are arranged abutting against the first step surface 13 and the shift plate 50 along the shaft axis a, respectively, to limit the sliding sleeve 20 from sliding along the shaft axis a relative to the rotation shaft 10, so that the sliding sleeve 20 can rotate around the shaft axis a relative to the rotation shaft 10, but cannot slide along the shaft axis a relative to the rotation shaft 10.

In some non-limiting embodiments or aspects, the shift plate 50 is provided with a first fixing hole 51, and the second connection end 12 is provided with a second fixing hole 122. The earphone adjustment structure 100 also includes a fastener 60, and the fastener 60 is configured penetrating the first fixing hole 51 and the second fixing hole 122 to connect the shift plate 50 to the second connection end 12.

In some non-limiting embodiments or aspects, the fastener 60 is a screw, a bolt, etc., and the first fixing hole 51 and/or the second fixing hole 122 are threaded holes.

It should be noted that, in non-limiting embodiments or aspects, the shift plate 50 may also be connected to the second connection end 12 by bonding, clamping, buckling, etc.

In non-limiting embodiments or aspects of the present disclosure, referring to FIG. 3 and FIG. 5, the earphone adjustment structure 100 also includes a torsion spring 70, which is disposed in the sliding sleeve 20 and sleeved on the rotation shaft 10. The torsion spring 70 is configured to provide a restoring force to the sliding sleeve 20.

Specifically, one end of the torsion spring 70 is connected to the rotation shaft 10, and the other end of the torsion spring 70 is connected to the sliding sleeve 20. When wearing, the torsion spring 70 provides a restoring force for the sliding sleeve 20, so that the sliding sleeve 20 has a tendency to return to the original position due to the restoring force, and then the fixed sleeve 30 and the earphone body 200 have a tendency to return to the original position. In this way, the earphone body 200 can be forced to fit on the user's ear when worn. Among them, the magnitude of the restoring force may be determined according to experiments, with the goal of meeting the needs but not compressing the user's ear to make the user's ear uncomfortable.

In non-limiting embodiments or aspects of the present disclosure, the second connection end 12 is provided with a rectangular clamping part 121, the torsion spring 70 is formed with a rectangular hole 71, the torsion spring 70 is sleeved on the rectangular clamping part 121 through the rectangular hole 71, the side wall of the sliding sleeve 20 is provided with a clamping slot 23, the torsion spring 70 has a clamping foot 72, and the clamping foot 72 abuts against the clamping slot 23.

Optionally, the rectangular clamping part 121 is adapted to the rectangular hole 71, and when the torsion spring 70 is sleeved on the rectangular clamping part 121 through the rectangular hole 71, that is, when the rectangular clamping part 121 is arranged passing through the rectangular hole 71, the torsion spring 70 and the rotation shaft 10 are fixed in the circumferential direction, so that the torsion spring 70 cannot rotate relative to the rectangular clamping part 121 around the shaft axis a. The sliding sleeve 20 is provided with a through hole 24 near the second connection end 12, and a clamping slot 23 is provided on the outer wall of the sliding sleeve 20, and the clamping slot 23 is in communication with the through hole 24. The clamping foot 72, passing through the through hole 24, is extended into the clamping slot 23 and abuts against the side wall of the clamping slot 23, to realize a circumferential fixation of the torsion spring 70 and the sliding sleeve 20, so that when the sliding sleeve 20 rotates around the shaft axis a, the torque of the torsion spring 70 is increased, and a restoring force is provided for the reset of the sliding sleeve 20.

Specifically, the torsion spring 70 has multiple working states. When the rotation shaft 10 and the sliding sleeve 20 are in the original position relative to each other, the torsion spring 70 is in a pre-compression state, and an initial torsion is provided as a restoring force. When the sliding sleeve 20 and the rotation shaft 10 are rotated relative to each other by external force, the torsion state of the torsion spring 70 is increased, and the torsion provided is increased. At this time, the earphone body 200 can adaptively fit the user's ear under the action of the torsion. When the external force on the rotation shaft 10 and the sliding sleeve 20 disappears, the torsion of the torsion spring 70 acts as a restoring force, driving the rotation shaft 10 and the sliding sleeve 20 to return to the original position.

It should be noted that, in non-limiting embodiments or aspects, a spring sheet or other components that can provide a restoring force for the sliding sleeve 20 may also be used.

In non-limiting embodiments or aspects of the present disclosure, referring to FIG. 3, a second step surface 14 is formed on the rotation shaft 10, and the second step surface 14 and the shift plate 50 are arranged oppositely and spaced apart along the shaft axis a, and the torsion spring 70 is arranged along the shaft axis a between the second step surface 14 and the shift plate 50.

Specifically, the second step surface 14 is arranged near the second connection end 12, and the torsion spring 70 is arranged between the second step surface 14 and the shift plate 50 along the shaft axis a, so that the torsion spring 70 is stably sleeved on the rotation shaft 10 to prevent the torsion spring 70 from being separated from the rotation shaft 10 along the shaft axis a.

In non-limiting embodiments or aspects of the present disclosure, referring to FIGS. 3 and 4, the rotation shaft 10 is provided with a first wiring hole 15, the side wall of the sliding sleeve 20 is provided with a second wiring hole 25, and the side wall of the fixed sleeve 30 is provided with a third wiring hole 32. The first wiring hole 15, the second wiring hole 25 and the third wiring hole 32 are communicated in sequence.

The first wiring hole 15 penetrates the side wall of the rotation shaft 10 at the first connection end 11. The first wiring hole 15, the second wiring hole 25 and the third wiring hole 32 are provided for a conductive member to be passed through. The conductive member is configured to electrically connect the components in the ear hook 300 with the components in the earphone body 200. For example, the conductive member is a wire, one end of which is electrically connected to a battery inside the ear hook 300, and the other end passes through the first wiring hole 15, the second wiring hole 25 and the third wiring hole 32 in sequence, and is electrically connected to a circuit board of the earphone body 200.

In non-limiting embodiments or aspects of the present disclosure, referring to FIGS. 3 and 5, the earphone adjustment structure 100 also includes a decorative cover 80, which is sealed at an end portion of the fixed sleeve 30 close to the second connection end 12 to cover the components in the fixed sleeve 30.

Referring to FIG. 1, non-limiting embodiments or aspects of the present disclosure also provides an ear-hook type earphone, which includes an earphone body 200, an ear hook 300 and the earphone adjustment structure 100 of any of the above non-limiting embodiments or aspects. One end of the rotation shaft 10 is connected to the ear hook 300, and the fixed sleeve 30 is connected to the earphone body 200.

The above description merely illustrates certain embodiments of the present disclosure and is not intended to limit the present disclosure. Any modification, equivalent replacement and improvement made within the spirit and principle of the present disclosure shall all be included within the protection scope of the present disclosure.

What is claimed is:

1. An earphone adjustment structure, comprising:
a rotation shaft, having a shaft axis, wherein one end of the rotation shaft along the shaft axis is configured to be connected to an ear hook of an ear-hook type earphone;
a sliding sleeve, sleeved on the rotation shaft and capable of rotating relative to the rotation shaft around the shaft axis; and
a fixed sleeve, sleeved on the sliding sleeve, capable of sliding relative to the rotation shaft and the sliding sleeve along the shaft axis, and capable of being maintained at a preset position along the shaft axis, wherein the fixed sleeve is enabled to rotate synchronously with the sliding sleeve around the shaft axis relative to the rotation shaft, and the fixed sleeve is configured to be connected to an earphone body of the ear-hook type earphone.

2. The earphone adjustment structure according to claim 1, wherein a displacement of the fixed sleeve along the shaft axis relative to the sliding sleeve and the rotation shaft is in a range of 0-2 mm.

3. The earphone adjustment structure according to claim 1, wherein the earphone adjustment structure further comprises a resistance ring, the resistance ring is sleeved on an outer wall of the sliding sleeve and abuts against an inner wall of the fixed sleeve.

4. The earphone adjustment structure according to claim 3, wherein the fixed sleeve is provided with an annular recess arranged around the shaft axis, and the resistance ring is accommodated in the annular recess.

5. The earphone adjustment structure according to claim 1, wherein a guide slot is provided on a side wall of the sliding sleeve, a guide block is provided on an inner wall of the fixed sleeve, and the guide block is slidably arranged in the guide slot along the shaft axis; or
the guide block is provided on an outer wall of the sliding sleeve, the guide slot is provided on the side wall of the fixed sleeve, and the guide block is slidably arranged in the guide slot along the shaft axis.

6. The earphone adjustment structure according to claim 1, wherein a limit groove extending around the shaft axis is provided on an inner wall of the sliding sleeve, and two opposite ends of the limit groove are spaced apart and disconnected in a circumferential direction of the shaft axis, and a boss inserted into the limit groove is provided on a side wall of the rotation shaft; or
the limit groove extending around the shaft axis is provided on the side wall of the rotation shaft, and the two opposite ends of the limit groove are spaced apart and disconnected in the circumferential direction of the shaft axis, and the boss inserted into the limit groove is provided on the inner wall of the sliding sleeve.

7. The earphone adjustment structure according to claim 1, wherein the earphone adjustment structure further comprises a shift plate, the shift plate is connected to the rotation shaft, a first step surface is formed on the rotation shaft, the first step surface and the shift plate are arranged oppositely and spaced apart along the shaft axis, and two ends of the sliding sleeve along the shaft axis abut against the first step surface and the shift plate respectively.

8. The earphone adjustment structure according to claim 1, wherein the earphone adjustment structure further comprises a torsion spring, the torsion spring is arranged within the sliding sleeve and sleeved on the rotation shaft, and the torsion spring is configured to provide a restoring force to the sliding sleeve.

9. The earphone adjustment structure according to claim 8, wherein the earphone adjustment structure further comprises a shift plate, the shift plate is connected to the rotation shaft, a second step surface is formed on the rotation shaft, the second step surface and the shift plate are arranged oppositely and spaced apart along the shaft axis, and the torsion spring is arranged between the second step surface and the shift plate along the shaft axis.

10. An ear-hook type earphone, comprising:
an earphone body;
an ear hook; and
an earphone adjustment structure, comprising:
a rotation shaft, having a shaft axis, wherein one end of the rotation shaft along the shaft axis is connected to the ear hook of an ear-hook type earphone;
a sliding sleeve, sleeved on the rotation shaft and capable of rotating relative to the rotation shaft around the shaft axis; and
a fixed sleeve, sleeved on the sliding sleeve, capable of sliding relative to the rotation shaft and the sliding sleeve along the shaft axis, and capable of being maintained at a preset position along the shaft axis, wherein the fixed sleeve is enabled to rotate synchronously with the sliding sleeve around the shaft axis relative to the rotation shaft, and the fixed sleeve is connected to the earphone body of the ear-hook type earphone.

11. The ear-hook type earphone according to claim 10, wherein a displacement of the fixed sleeve along the shaft axis relative to the sliding sleeve and the rotation shaft is in a range of 0-2 mm.

12. The ear-hook type earphone according to claim 10, wherein the earphone adjustment structure further comprises a resistance ring, the resistance ring is sleeved on an outer wall of the sliding sleeve and abuts against an inner wall of the fixed sleeve.

13. The ear-hook type earphone according to claim 12, wherein the fixed sleeve is provided with an annular recess arranged around the shaft axis, and the resistance ring is accommodated in the annular recess.

14. The ear-hook type earphone according to claim 10, wherein a guide slot is provided on a side wall of the sliding sleeve, a guide block is provided on an inner wall of the fixed sleeve, and the guide block is slidably arranged in the guide slot along the shaft axis; or
the guide block is provided on an outer wall of the sliding sleeve, the guide slot is provided on the side wall of the fixed sleeve, and the guide block is slidably arranged in the guide slot along the shaft axis.

15. The ear-hook type earphone according to claim 10, wherein a limit groove extending around the shaft axis is provided on an inner wall of the sliding sleeve, and two opposite ends of the limit groove are spaced apart and disconnected in a circumferential direction of the shaft axis, and a boss inserted into the limit groove is provided on a side wall of the rotation shaft; or
the limit groove extending around the shaft axis is provided on the side wall of the rotation shaft, and the two opposite ends of the limit groove are spaced apart and disconnected in the circumferential direction of the shaft axis, and the boss inserted into the limit groove is provided on the inner wall of the sliding sleeve.

16. The ear-hook type earphone according to claim 10, wherein the earphone adjustment structure further comprises a shift plate, the shift plate is connected to the rotation shaft, a first step surface is formed on the rotation shaft, the first step surface and the shift plate are arranged oppositely and spaced apart along the shaft axis, and two ends of the sliding sleeve along the shaft axis abut against the first step surface and the shift plate respectively.

17. The ear-hook type earphone according to claim 10, wherein the earphone adjustment structure further comprises a torsion spring, the torsion spring is arranged within the sliding sleeve and sleeved on the rotation shaft, and the torsion spring is configured to provide a restoring force to the sliding sleeve.

18. The ear-hook type earphone according to claim 17, wherein the earphone adjustment structure further comprises a shift plate, the shift plate is connected to the rotation shaft, a second step surface is formed on the rotation shaft, the second step surface and the shift plate are arranged oppositely and spaced apart along the shaft axis, and the torsion spring is arranged between the second step surface and the shift plate along the shaft axis.
